(19) United States
(12) Patent Application Publication
(10) Pub. No.: US 2023/0169024 A1
(43) Pub. Date: Jun. 1, 2023

(54) SIGNAL PROCESSING DEVICE, AND ELECTRONIC APPARATUS INCLUDING THE SAME

(71) Applicant: LG ELECTRONICS INC., Seoul (KR)

(72) Inventor: Jaeyup LEE, Seoul (KR)

(73) Assignee: LG ELECTRONICS INC., Seoul (KR)

(21) Appl. No.: 17/921,875

(22) PCT Filed: Apr. 28, 2020
(86) PCT No.: PCT/KR2020/005584

§ 371 Date: Oct. 27, 2022

(51) Int. Cl. G06F 13/16

(52) U.S. Cl. CPC G06F 13/1689

(57) ABSTRACT

The present disclosure relates to an image display apparatus. An electronic apparatus according to one embodiment of the present disclosure comprises a memory configured to store data, and a signal processor configured to receive a strobe signal and data from the memory, wherein the data include odd data received during an odd data period and even data received during an even data period, and the signal processor is configured to: generate a first strobe signal for the odd data based on the strobe signal, generate a second strobe signal for the even data based on the strobe signal, detect the odd data based on the first strobe signal, and detect the even data based on the second strobe signal. Accordingly, data may be received in a stable manner from the memory.

### BACKGROUND

### 1. Field of the disclosure

The present disclosure relates to a signal processing device and an electronic apparatus including the same and, more particularly, to an image display apparatus capable of receiving data in a stable manner from a memory.

### 2. Description of the Related Art

A signal processing device is a device that processes input data, and outputs the processed data.

For example, when a memory and a signal processing device are provided within an electronic apparatus, data may be received from the memory, and the received data may be processed.

Meanwhile, as the amount of data received from the memory increases, the data transmission speed or the frequency of a strobe signal increases.

However, when the data transmission speed or the frequency of the strobe signal increases, a problem arises in that a margin for receiving data in a stable manner becomes small.

### SUMMARY

An object of the present disclosure is to provide an image display apparatus capable of receiving data in a stable manner from a memory.

Another object of the present disclosure is to provide an image display apparatus capable of receiving data in a stable manner from a Double Data Rate (DDR) memory.

Further another object of the present disclosure is to provide an image display apparatus capable of receiving data in a stable manner from a memory according to the increase of a data transmission speed or the frequency of a strobe signal.

To achieve the objects above, an electronic apparatus according to one embodiment of the present disclosure comprises a memory configured to store data, and a signal processor configured to receive a strobe signal and data from the memory, wherein the data include odd data received during an odd data period and even data received during an even data period, and the signal processor is configured to: generate a first strobe signal for the odd data based on the received strobe signal, generate a second strobe signal for the even data based on the received strobe signal, detect the odd data based on the first strobe signal, and detect the even data based on the second strobe signal.

Meanwhile, in response to the odd data period and the even data period the signal processor having different duty cycles, the signal processor may detect the odd data based on the first strobe signal, and detect the even data based on the second strobe signal.

Meanwhile, in response to the odd data period and the even data period having different duty cycles, the signal processor may detect a first center point for the odd data based on the first strobe signal, detect the odd data based on the first center point, detect a second center point for the even data based on the second strobe signal, and detect the even data based on the second center point.

Meanwhile, the margin of odd data, and even data detected based on the strobe signal from the memory may be larger than the margin of odd data, and even data detected based on the first strobe signal, and the second strobe signal.

Meanwhile, as the frequency of the strobe signal or the transmission speed of the received data increases, the margin of odd data, and even data detected based on the first strobe signal, and the second strobe signal may increase more than the margin of odd data, and even data detected based on the strobe signal from the memory.

Meanwhile, as the frequency of the strobe signal or the transmission speed of the received data increases, a difference between duty cycles of the odd data period and the even data period may increase, and a difference between the margin of odd data, and even data detected based on the strobe signal from the memory and the margin of odd data, and even data detected based on the first strobe signal, and the second strobe signal may increase.

Meanwhile, the signal processor may include a first delay cell configured to generate a first strobe signal for the odd data based on the strobe signal, and a second delay cell configured to generate a second strobe signal for the even data based on the strobe signal.

Meanwhile, the signal processor may further include a controller controlling the first delay cell and the second delay cell.

To achieve the objects above, an electronic apparatus according to another embodiment of the present disclosure comprises a memory configured to store data, and a signal processor configured to receive a strobe signal and data from the memory, wherein the data include odd data received during an odd data period and even data received during an even data period, and the signal processor is configured to: generate a first reference voltage corresponding to the odd data, generate a second reference voltage corresponding to the even data, detect the odd data based on the first reference voltage, and detect the even data based on the second reference voltage.

Meanwhile, in response to the odd data period and the even data period having different reference voltages, the signal processor may detect the odd data based on the first reference voltage and detect the even data based on the second reference voltage.

Meanwhile, the margin of odd data, and even data detected based on the first reference voltage and the second reference voltage may be larger than the margin of odd data, and even data detected based on a common reference voltage commonly corresponding to the odd data, and the even data.

Meanwhile, as the frequency of the strobe signal or the transmission speed of the received data increases, the margin of odd data, and even data detected based on the first reference voltage and the second reference voltage may increase more than the margin of odd data, and even data detected based on a common reference voltage commonly corresponding to the odd data, and the even data.

Meanwhile, as the frequency of the strobe signal or the transmission speed of the received data increases, a voltage difference between the odd data period and the even data period may increase, and a difference between the margin of odd data, and even data detected based on a common reference voltage commonly corresponding to the odd data, and the even data, and the margin of odd data, and even data detected based on the first reference voltage and the second reference voltage may increase.

Meanwhile, the signal processor may include a first reference voltage generator configured to generate the first reference voltage based on odd data among the data, and a second reference voltage generator configured to generate the second reference voltage based on even data among the data.

Meanwhile, the signal processor may further include a controller controlling the first reference voltage generator and the second reference voltage generator.

To achieve the objects above, a signal processing device according to one embodiment of the present disclosure receives a strobe signal from a memory, odd data received during an odd data period, and even data received during an even data period, wherein the signal processing device includes a first delay cell configured to generate a first strobe signal for the odd data based on the received strobe signal, and a second delay cell configured to generate a second strobe signal for the even data based on the received strobe signal, detect the odd data based on the first strobe signal, and detect the even data based on the second strobe signal.

To achieve the objects above, a signal processing device according to another embodiment of the present disclosure receives a strobe signal from a memory, odd data received during an odd data period, and even data received during an even data period, wherein the signal processing device includes a first reference voltage generator configured to generate a first reference voltage corresponding to the odd data, and a second reference voltage generator configured to generate a second reference voltage corresponding to the even data, detect the odd data based on the first reference voltage, and detect the even data based on the second reference voltage.

### EFFECTS OF THE DISCLOSURE

An electronic apparatus according to one embodiment of the present disclosure comprises a memory configured to store data, and a signal processor configured to receive a strobe signal and data from the memory, wherein the data include odd data received during an odd data period and even data received during an even data period, and the signal processor is configured to: generate a first strobe signal for the odd data based on the received strobe signal, generate a second strobe signal for the even data based on the received strobe signal, detect the odd data based on the first strobe signal, and detect the even data based on the second strobe signal. Accordingly, data may be received in a stable manner from a memory. In particular, an improved effective area may be secured at the time of data reception based on the first and second strobe signals.

Meanwhile, in response to the odd data period and the even data period the signal processor having different duty cycles, the signal processor may detect the odd data based on the first strobe signal, and detect the even data based on the second strobe signal. Accordingly, data may be received in a stable manner from a memory.

Meanwhile, in response to the odd data period and the even data period having different duty cycles, the signal processor may detect a first center point for the odd data based on the first strobe signal, detect the odd data based on the first center point, detect a second center point for the even data based on the second strobe signal, and detect the even data based on the second center point. Accordingly, data may be received in a stable manner from a memory. In particular, an improved effective area may be secured at the time of data reception based on the first and second strobe signals.

Meanwhile, the margin of odd data, and even data detected based on the strobe signal from the memory may be larger than the margin of odd data, and even data detected based on the first strobe signal, and the second strobe signal. Accordingly, data may be received in a stable manner from a memory.

Meanwhile, as the frequency of the strobe signal or the transmission speed of the received data increases, the margin of odd data, and even data detected based on the first strobe signal, and the second strobe signal may increase more than the margin of odd data, and even data detected based on the strobe signal from the memory. Accordingly, even if the frequency of a strobe signal or the transmission speed of received data increases, data may be received in a stable manner from a memory.

Meanwhile, as the frequency of the strobe signal or the transmission speed of the received data increases, a difference between duty cycles of the odd data period and the even data period may increase, and a difference between the margin of odd data, and even data detected based on the strobe signal from the memory and the margin of odd data, and even data detected based on the first strobe signal, and the second strobe signal may increase. Accordingly, even if the frequency of a strobe signal or the transmission speed of received data increases, data may be received in a stable manner from a memory.

Meanwhile, the signal processor may include a first delay cell configured to generate a first strobe signal for the odd data based on the strobe signal, and a second delay cell configured to generate a second strobe signal for the even data based on the strobe signal. Accordingly, data may be received in a stable manner from a memory. In particular, an improved effective area may be secured at the time of data reception based on the first and second strobe signals.

Meanwhile, the signal processor may further include a controller controlling the first delay cell and the second delay cell. Accordingly, data may be received in a stable manner from a memory.

Meanwhile, an electronic apparatus according to another embodiment of the present disclosure comprises a memory configured to store data, and a signal processor configured to receive a strobe signal and data from the memory, wherein the data include odd data received during an odd data period and even data received during an even data period, and the signal processor is configured to: generate a first reference voltage corresponding to the odd data, generate a second reference voltage corresponding to the even data, detect the odd data based on the first reference voltage, and detect the even data based on the second reference voltage. Accordingly, data may be received in a stable manner from a memory. In particular, an improved effective area may be secured at the time of data reception based on the first and second reference voltages.

Meanwhile, in response to the odd data period and the even data period having different reference voltages, the signal processor may detect the odd data based on the first reference voltage and detect the even data based on the second reference voltage. Accordingly, data may be received in a stable manner from a memory. In particular, an improved effective area may be secured at the time of data reception based on the first and second reference voltages.

Meanwhile, the margin of odd data, and even data detected based on the first reference voltage and the second reference voltage may be larger than the margin of odd data, and even data detected based on a common reference voltage commonly corresponding to the odd data, and the even data. Accordingly, data may be received in a stable manner from a memory.

Meanwhile, as the frequency of the strobe signal or the transmission speed of the received data increases, the margin of odd data, and even data detected based on the first reference voltage and the second reference voltage may increase more than the margin of odd data, and even data detected based on a common reference voltage commonly corresponding to the odd data, and the even data. Accordingly, even if the frequency of a strobe signal of the transmission speed of received data increases, data may be received in a stable manner from a memory.

Meanwhile, as the frequency of the strobe signal or the transmission speed of the received data increases, a voltage difference between the odd data period and the even data period may increase, and a difference between the margin of odd data, and even data detected based on a common reference voltage commonly corresponding to the odd data, and the even data, and the margin of odd data, and even data detected based on the first reference voltage and the second reference voltage may increase. Accordingly, even if the frequency of a strobe signal of the transmission speed of received data increases, data may be received in a stable manner from a memory.

Meanwhile, the signal processor may include a first reference voltage generator configured to generate the first reference voltage based on odd data among the data, and a second reference voltage generator configured to generate the second reference voltage based on even data among the data. Accordingly, data may be received in a stable manner from a memory.

Meanwhile, the signal processor may further include a controller controlling the first reference voltage generator and the second reference voltage generator. Accordingly, data may be received in a stable manner from a memory.

Meanwhile, a signal processing device according to one embodiment of the present disclosure receives a strobe signal from a memory, odd data received during an odd data period, and even data received during an even data period, wherein the signal processing device includes a first delay cell configured to generate a first strobe signal for the odd data based on the received strobe signal, and a second delay cell configured to generate a second strobe signal for the even data based on the received strobe signal, detect the odd data based on the first strobe signal, and detect the even data based on the second strobe signal. Accordingly, data may be received in a stable manner from a memory. In particular, an improved effective area may be secured at the time of data reception based on the first and second strobe signals.

Meanwhile, a signal processing device according to another embodiment of the present disclosure receives a strobe signal from a memory, odd data received during an odd data period, and even data received during an even data period, wherein the signal processing device includes a first reference voltage generator configured to generate a first reference voltage corresponding to the odd data, and a second reference voltage generator configured to generate a second reference voltage corresponding to the even data, detect the odd data based on the first reference voltage, and detect the even data based on the second reference voltage. Accordingly, data may be received in a stable manner from a memory. In particular, an improved effective area may be secured at the time of data reception based on the first and second reference voltages.

### BRIEF DESCRIPTION OF THE DRAWINGS

FIG. 1 shows an image display apparatus which is one example of an electronic apparatus according to one embodiment of the present disclosure.

FIG. 2 is an example of an internal block diagram of the image display apparatus of FIG. 1.

FIG. 3 is an example of an internal block diagram of the signal processor in FIG. 2.

FIG. 4A is a diagram illustrating a control method of a remote controller of FIG. 2.

FIG. 4B is an internal block diagram of the remote controller of FIG. 2.

FIG. 5 is an internal block diagram of a display of FIG. 2.

FIG. 6A and FIG. 6B are diagrams referred to in the description of an organic light emitting diode panel of FIG. 5.

FIG. 7A illustrates a memory and a signal processor within an electronic apparatus according to one embodiment of the present disclosure.

FIGS. 7B to 14 are diagrams referred to in the description of the signal processor of FIG. 7A.

### DETAILED DESCRIPTION OF THE PREFERRED EMBODIMENTS

Hereinafter, the present disclosure will be described in detail with reference to the accompanying drawings.

With respect to constituent elements used in the following description, suffixes “module” and “unit” are given only in consideration of ease in the preparation of the specification, and do not have or serve as different meanings. Accordingly, the suffixes “module” and “unit” may be used interchangeably.

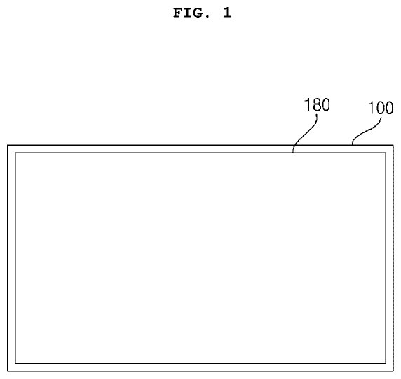

FIG. 1 shows an image display apparatus which is one example of an electronic apparatus according to one embodiment of the present disclosure.

Referring to the drawing, an image display apparatus 100 may include a display 180.

An electronic apparatus, particularly, the image display apparatus 100 may include a signal processor 170 for signal processing and a memory 140 therein.

Meanwhile, data is exchanged between the signal processor 170 and the memory 140. For example, the signal processor 170 may control data to be stored in the memory 140 and conversely, read data from the memory 140.

Meanwhile, as the amount of data received from the memory 140 to the signal processor 170 increases, the data transmission speed or the frequency of a strobe signal increases.

However, when the data transmission speed or the frequency of the strobe signal increases, a problem arises in that the margin for receiving data in a stable manner becomes small.

In particular, when the memory 140 is a double data rate (DDR) memory, as the data transmission speed or the frequency of the strobe signal increases, a difference in the duty cycle between an odd data period during which odd data are received and an even data period during which even data are received increases.

In particular, as the data transmission speed or the frequency of the strobe signal increases while the signal processor 170 transmits a clock signal to the memory 140, a difference in the duty cycle between the odd data period during which odd data are received and the even the odd data period during which even data are received increases.

In this case, when the odd data, and the even data are detected based on a common strobe signal, the margin for acquiring the odd data, and the even data becomes small.

In particular, as the data transmission speed or the frequency of the strobe signal increases, the margin for acquiring odd data, and even data becomes smaller. Accordingly, as the data transmission speed or the frequency of the strobe signal increases, the instability of receiving data by the signal processor 170 increases.

Accordingly, in one embodiment of the present disclosure, to solve the problem above, a method for detecting odd data, and even data using a first strobe signal for odd data, and a second strobe signal for even data rather than using a common strobe signal is proposed to detect odd data, and even data.

In other words, an electronic apparatus according to one embodiment of the present disclosure, in particular, the image display apparatus 100 comprises a memory 140 storing data, and a signal processor 170 receiving a strobe signal

Strobe and data from the memory 140, wherein the data include odd data received during an odd data period Pma and even data received during an even data period Pmb; and the signal processor 170 generates a first strobe signal Strobe_Odd for the odd data based on the received strobe signal Strobe, generate a second strobe signal Strobe_Even for the even data based on the received strobe signal Strobe, detect the odd data based on the first strobe signal Strobe_Odd, and detect the even data based on the second strobe signal Strobe_Even. Accordingly, data may be received in a stable manner from the memory 140. In particular, an improved effective area may be secured at the time of data reception based on the first strobe signal Strobe_Odd and the second strobe signal Strobe_Even.

On the other hand, when the odd data period Pma and the even data period Pmb have different duty cycles, the signal processor 170 may detect odd data based on the first strobe signal Strobe_Odd and detect even data based on the second strobe signal Strobe_Even. Accordingly, data may be received in a stable manner from the memory 140.

On the other hand, when the memory 140 is a double data rate (DDR) memory, as the data transmission speed or the frequency of the strobe signal increases, a difference between the reference voltage for odd data, and the reference for even data increases.

In particular, as the data transmission speed or the frequency of the strobe signal increases as the signal processor 170 transmits a clock signal to the memory 140, the difference between the reference voltage for the odd data, and the reference voltage for the even data increases.

In this case, when the odd data, and the even data are detected based on a common reference voltage, the margin for acquiring the odd and even data becomes small.

In particular, as the data transmission speed or the frequency of the strobe signal increases, the margin for acquiring the odd data, and the even data becomes smaller. Accordingly, as the data transmission rate or the frequency of the strobe signal increases, the instability of receiving data by the signal processor 170 increases.

Accordingly, in one embodiment of the present disclosure, to solve the problem above, a method for detecting odd data, and even data using a first reference voltage for odd data, and a second reference voltage for even data rather than using a common reference voltage is proposed to detect odd data, and even data.

Accordingly, an electronic apparatus according to another embodiment of the present disclosure, in particular, the image display apparatus 100 comprises a memory configured to store data, and a signal processor configured to receive a strobe signal Strobe and data from the memory, wherein the data include odd data received during an odd data period Pma and even data received during an even data period Pmb; and the signal processor 170 generates a first reference voltage VREF1 corresponding to the odd data, generate a second reference voltage VREF2 corresponding to the even data, detect the odd data based on the first reference voltage VREF1, and detect the even data based on the second reference voltage VREF2. Accordingly, data may be received in a stable manner from a memory 140. In particular, an improved effective area may be secured at the time of data reception based on the first reference voltage VREF1 and the second reference voltage VREF2.

Meanwhile, when the odd data period Pma and the even data period Pmb have different reference voltages, the signal processor 170 may detect the odd data based on the first reference voltage VREF1 and detect the even data based on the second reference voltage VREF2. Accordingly, data may be received in a stable manner from a memory 140. In particular, an improved effective area may be secured at the time of data reception based on the first reference voltage VREF1 and the second reference voltage VREF2.

Meanwhile, the image display apparatus 100 of FIG. 1 may be implemented using a monitor, a TV, a table PC, a mobile terminal, an in-vehicle display apparatus, and the like.

Meanwhile, examples of the electronic apparatus according to an embodiment of the present disclosure may include an image display apparatus, an image processing device, an audio processing device, a refrigerator, a washing machine, an air conditioner, an air purifier, a robot cleaner, a home appliance such as a vacuum cleaner, an electronic door, a camera, a drone, and a vehicle.

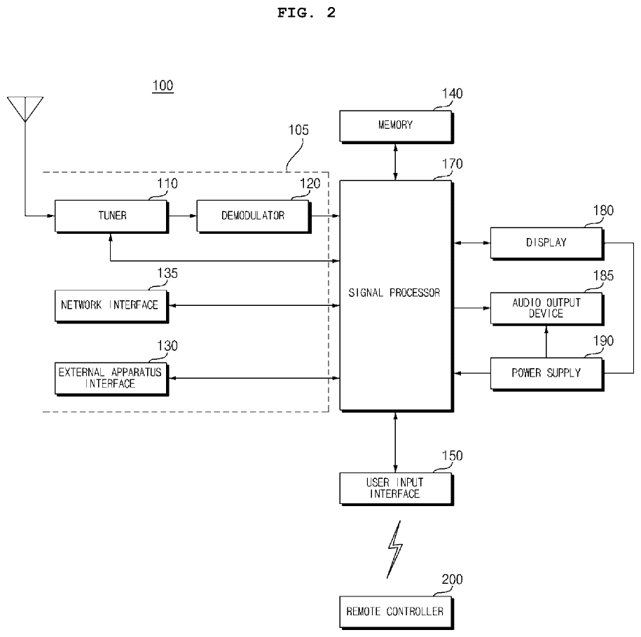

FIG. 2 is an example of an internal block diagram of the image display apparatus of FIG. 1.

Referring to FIG. 2, the image display apparatus 100 according to an embodiment of the present disclosure includes an image receiver 105, an external apparatus interface 130, a memory 140, a user input interface 150, a sensor device (not shown), a signal processor 170, a display 180, and an audio output device 185.

The image receiver 105 may include a tuner 110, a demodulator 120, a network interface 135, and an external apparatus interface 130.

Meanwhile, unlike the drawing, the image receiver 105 may include only the tuner 110, the demodulator 120, and the external apparatus interface 130. That is, the network interface 135 may not be included.

The tuner 110 selects an RF broadcast signal corresponding to a channel selected by a user or all prestored channels among radio frequency (RF) broadcast signals received through an antenna (not shown). In addition, the selected RF broadcast signal is converted into an intermediate frequency signal, a baseband image, or an audio signal.

For example, if the selected RF broadcast signal is a digital broadcast signal, it is converted into a digital IF signal (DIF). If the selected RF broadcast signal is an analog broadcast signal, it is converted into an analog baseband image or audio signal (CVBS/SIF). That is, the tuner 110 can process a digital broadcast signal or an analog broadcast signal. The analog baseband image or audio signal (CUBS/SIF) output from the tuner 110 may be directly input to the signal processor 170.

Meanwhile, the tuner 110 can include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may perform demodulation and channel decoding and then output a stream signal TS. At this time, the stream signal may be a multiplexed signal of an image signal, an audio signal, or a data signal.

The stream signal output from the demodulator 120 may be input to the signal processor 170. The signal processor 170 performs demultiplexing, image/audio signal processing, and the like, and then outputs an image to the display 180 and outputs audio to the audio output device 185.

The external apparatus interface 130 may transmit or receive data with a connected external apparatus (not shown), e.g., a set-top box 50. To this end, the external apparatus interface 130 may include an A/V input and output device (not shown).

The external apparatus interface 130 may be connected in wired or wirelessly to an external apparatus such as a digital versatile disk (DVD), a Blu ray, a game equipment, a camera, a camcorder, a computer(notebook), and a set-top box, and may perform an input/output operation with an external apparatus.

The A/V input and output device may receive image and audio signals from an external apparatus. Meanwhile, a wireless transceiver (not shown) may perform short range wireless communication with other electronic apparatus.

Through the wireless transceiver (not shown), the external apparatus interface 130 may exchange data with an adjacent mobile terminal 600. In particular, in a mirroring mode, the external apparatus interface 130 may receive device information, executed application information, application image, and the like from the mobile terminal 600.

The network interface 135 provides an interface for connecting the image display apparatus 100 to a wired/wireless network including the Internet network. For example, the network interface 135 may receive, via the network, content or data provided by the Internet, a content provider, or a network operator.

Meanwhile, the network interface 135 may include a wireless transceiver (not shown).

The memory 140 may store a program for each signal processing and control in the signal processor 170, and may store signal processed image, audio, or data signal.

In addition, the memory 140 may serve to temporarily store image, audio, or data signal input to the external apparatus interface 130. In addition, the memory 140 may store information on a certain broadcast channel through a channel memory function such as a channel map.

Although FIG. 2 illustrates that the memory is provided separately from the signal processor 170, the scope of the present disclosure is not limited thereto. The memory 140 may be included in the signal processor 170.

The user input interface 150 transmits a signal input by the user to the signal processor 170 or transmits a signal from the signal processor 170 to the user.

For example, it may transmit/receive a user input signal such as power on/off, channel selection, screen setting, etc., from a remote controller 200, may transfer a user input signal input from a local key (not shown) such as a power key, a channel key, a volume key, a set value, etc., to the signal processor 170, may transfer a user input signal input from a sensor device (not shown) that senses a user's gesture to the signal processor 170, or may transmit a signal from the signal processor 170 to the sensor device (not shown).

The signal processor 170 may demultiplex the input stream through the tuner 110, the demodulator 120, the network interface 135, or the external apparatus interface 130, or process the demultiplexed signals to generate and output a signal for image or audio output.

For example, the signal processor 170 is configured to receive a broadcast signal received by the image receiver 105 or an HDMI signal, and perform signal processing based on the received broadcast signal or the HDMI signal to thereby output a processed image signal.

The image signal processed by the signal processor 170 is input to the display 180 and may be displayed as an image corresponding to the image signal. In addition, the image signal processed by the signal processor 170 may be input to the external output apparatus through the external apparatus interface 130.

The audio signal processed by the signal processor 170 may be output to the audio output device 185 as an audio signal. In addition, audio signal processed by the signal processor 170 may be input to the external output apparatus through the external apparatus interface 130.

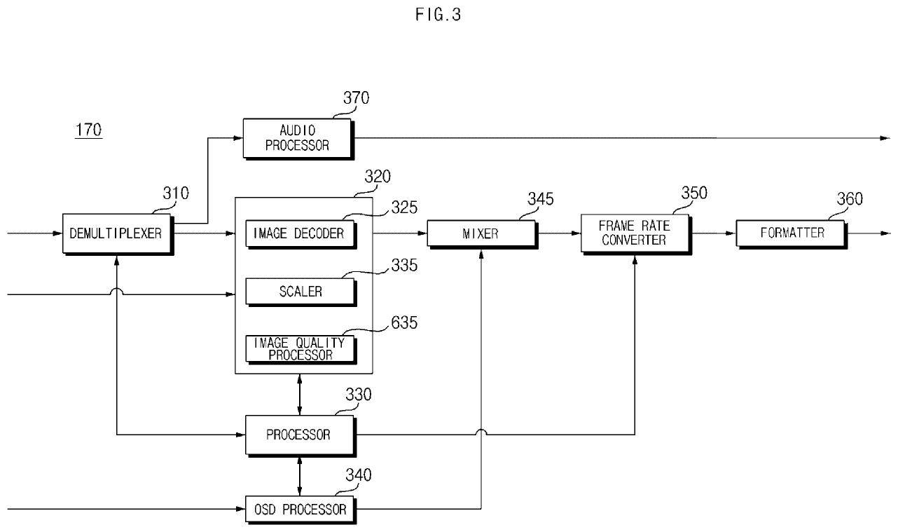

Although not shown in FIG. 2, the signal processor 170 may include a demultiplexer, an image processor, and the like. That is, the signal processor 170 may perform a variety of signal processing and thus it may be implemented in the form of a system on chip (SOC). This will be described later with reference to FIG. 3.

In addition, the signal processor 170 can control the overall operation of the image display apparatus 100. For example, the signal processor 170 may control the tuner 110 to control the tuning of the RF broadcast corresponding to the channel selected by the user or the previously stored channel.

In addition, the signal processor 170 may control the image display apparatus 100 according to a user command input through the user input interface 150 or an internal program.

Meanwhile, the signal processor 170 may control the display 180 to display an image. At this time, the image displayed on the display 180 may be a still image or a moving image and may be a 2D image or a 3D image.

Meanwhile, the signal processor 170 may display a certain object in an image displayed on the display 180. For example, the object may be at least one of a connected web screen (newspaper, magazine, etc.), an electronic program guide (EPG), various menus, a widget, an icon, a still image, a moving image, or a text.

Meanwhile, the signal processor 170 may recognize the position of the user based on the image photographed by a photographing device (not shown). For example, the distance (z-axis coordinate) between a user and the image display apparatus 100 can be determined. In addition, the x-axis coordinate and the y-axis coordinate in the display 180 corresponding to a user position can be determined.

The display 180 generates a driving signal by converting an image signal, a data signal, an OSD signal, a control signal processed by the signal processor 170, an image signal, a data signal, a control signal, and the like received from the external apparatus interface 130.

Meanwhile, the display 180 may be configured as a touch screen and used as an input device in addition to an output device.

The audio output device 185 receives a signal processed by the signal processor 170 and outputs it as an audio.

The photographing device (not shown) photographs a user. The photographing device (not shown) may be implemented by a single camera, but the present disclosure is not limited thereto and may be implemented by a plurality of cameras. Image information photographed by the photographing device (not shown) may be input to the signal processor 170.

The signal processor 170 may sense a gesture of the user based on each of the images photographed by the photographing device (not shown), the signals detected from the sensor device (not shown), or a combination thereof.

The power supply 190 supplies corresponding power to the image display apparatus 100. Particularly, the power may be supplied to a controller 170 which can be implemented in the form of a system on chip (SOC), a display 180 for displaying an image, and an audio output device 185 for outputting an audio.

Specifically, the power supply 190 may include a converter for converting an AC power into a DC power, and a DC/DC converter for converting the level of the DC power.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may receive the image, audio, or data signal output from the user input interface 150, and display it on the remote controller 200 or output it as an audio.

Meanwhile, the image display apparatus 100 may be a fixed or mobile digital broadcasting receiver capable of receiving digital broadcasting.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be divided into two or more components. The function performed in each block is described for the purpose of illustrating embodiments of the present disclosure, and specific operation and apparatus do not limit the scope of the present disclosure.

FIG. 3 is an example of an internal block diagram of the signal processor in FIG. 2.

Referring to the drawing, the signal processor 170 according to an embodiment of the present disclosure may include a demultiplexer 310, an image processor 320, a processor 330, and an audio processor 370. In addition, the signal processor 170 may further include and a data processor (not shown).

The demultiplexer 310 demultiplexes the input stream. For example, when an MPEG-2 TS is input, it can be demultiplexed into image, audio, and data signal, respectively. Here, the stream signal input to the demultiplexer 310 may be a stream signal output from the tuner 110, the demodulator 120, or the external apparatus interface 130.

The image processor 320 may perform signal processing on an input image. For example, the image processor 320 may perform image processing on an image signal demultiplexed by the demultiplexer 310.

To this end, the image processor 320 may include an image decoder 325, a scaler 335, an image quality processor 635, an image encoder (not shown), an OSD processor 340, a frame rate converter 350, a formatter 360, etc.

The image decoder 325 decodes a demultiplexed image signal, and the scaler 335 performs scaling so that the resolution of the decoded image signal can be output from the display 180.

The image decoder 325 can include a decoder of various standards. For example, a 3D image decoder for MPEG-2, H.264 decoder, a color image, and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may perform image quality processing on an input image signal decoded by the image decoder 325 or the like.

For example, the image quality processor 625 may perform noise reduction processing on an input image signal, extend a resolution of high gray level of the input image signal, perform image resolution enhancement, perform signal processing based on high dynamic range (HDR), change a frame rate, perform image quality processing suitable for properties of a panel, especially an OLED panel, etc.

The OSD processor 340 generates an OSD signal according to a user input or by itself. For example, based on a user input signal, the OSD processor 340 may generate a signal for displaying various pieces of information as a graphic or a text on the screen of the display 180. The generated OSD signal may include various data such as a user interface screen of the image display apparatus 100, various menu screens, a widget, and an icon. In addition, the generated OSD signal may include a 2D object or a 3D object.

In addition, the OSD processor 340 may generate a pointer that can be displayed on the display, based on a pointing signal input from the remote controller 200. In particular, such a pointer may be generated by a pointing signal processor, and the OSD processor 340 may include such a pointing signal processor (not shown). Obviously, the pointing signal processor (not shown) may be provided separately from the OSD processor 340.

A frame rate converter (FRC) 350 may convert a frame rate of an input image. The FRC 350 may output the input image without changes.

Meanwhile, the formatter 360 may change a format of an input image signal into a format suitable for displaying the image signal on a display and output the image signal in the changed format.

In particular, the formatter 360 may change a format of an image signal to correspond to a display panel.

Meanwhile, the formatter 360 may change the format of the image signal. For example, it may change the format of the 3D image signal into any one of various 3D formats such as a side by side format, a top/down format, a frame sequential format, an interlaced format, a checker box format, and the like.

The processor 330 may control overall operations of the image display apparatus 100 or the signal processor 170.

For example, the processor 330 may control the tuner 110 to control the tuning of an RF broadcast corresponding to a channel selected by a user or a previously stored channel.

In addition, the processor 330 may control the image display apparatus 100 according to a user command input through the user input interface 150 or an internal program.

In addition, the processor 330 may transmit data to the network interface 135 or to the external apparatus interface 130.

In addition, the processor 330 may control the demultiplexer 310, the image processor 320, and the like in the signal processor 170.

Meanwhile, the audio processor 370 in the signal processor 170 may perform the audio processing of the demultiplexed audio signal. To this end, the audio processor 370 may include various decoders.

In addition, the audio processor 370 in the signal processor 170 may process a base, a treble, a volume control, and the like.

The data processor (not shown) in the signal processor 170 may perform data processing of the demultiplexed data signal. For example, when the demultiplexed data signal is a coded data signal, it can be decoded. The encoded data signal may be electronic program guide information including broadcast information such as a start time and an end time of a broadcast program broadcasted on each channel.

Meanwhile, a block diagram of the signal processor 170 shown in FIG. 3 is a block diagram for an embodiment of the present disclosure. Each component of the block diagram may be integrated, added, or omitted according to a specification of the signal processor 170 actually implemented.

In particular, the frame rate converter 350 and the formatter 360 may be provided separately in addition to the image processor 320.

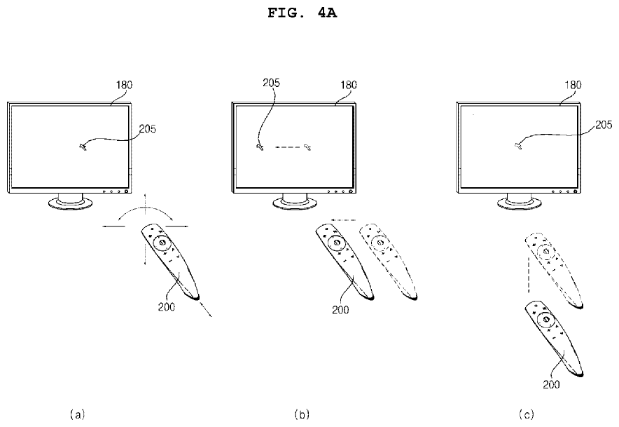

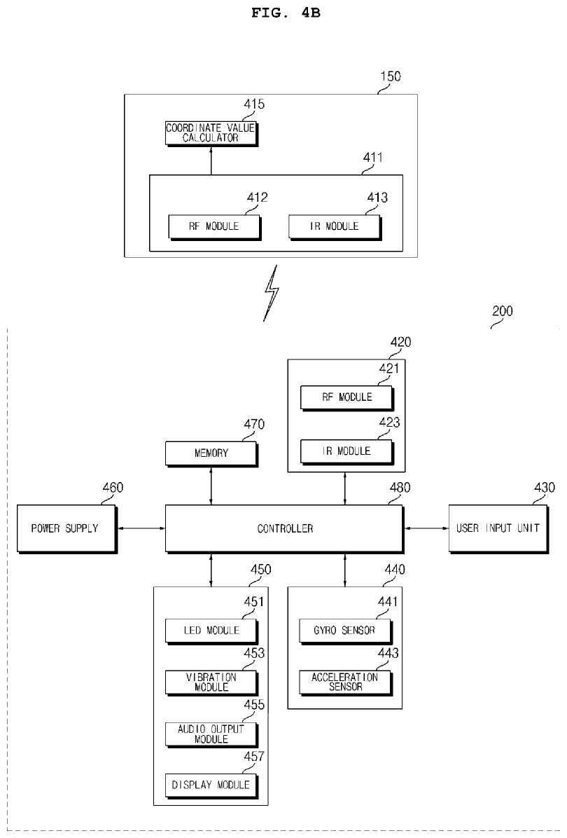

FIG. 4A is a diagram illustrating a control method of a remote controller of FIG. 2.

As shown in FIG. 4A(a), it is illustrated that a pointer 205 corresponding to the remote controller 200 is displayed on the display 180.

The user may move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the drawing.

FIG. 4A(b) illustrates that when the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A(c) illustrates a case where the user moves the remote controller 200 away from the display 180 while pressing a specific button of the remote controller 200. Thus, a selection area within the display 180 corresponding to the pointer 205 may be zoomed in so that it can be displayed to be enlarged. On the other hand, when the user moves the remote controller 200 close to the display 180, the selection area within the display 180 corresponding to the pointer 205 may be zoomed out so that it can be displayed to be reduced. Meanwhile, when the remote controller 200 moves away from the display 180, the selection area may be zoomed out, and when the remote controller 200 approaches the display 180, the selection area may be zoomed in.

Meanwhile, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 may correspond to the moving speed or the moving direction of the remote controller 200.

FIG. 4B is an internal block diagram of the remote controller of FIG. 2.

Referring to the drawing, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. When the user input device 435 includes a hard key button, the user can input a command related to the image display apparatus 100 to the remote controller 200 through a push operation of the hard key button. When the user input device 435 includes a touch screen, the user may touch a soft key of the touch screen to input the command related to the image display apparatus 100 to the remote controller 200. In addition, the user input device 435 may include various types of input means such as a scroll key, a jog key, etc., which can be operated by the user, and the present disclosure does not limit the scope of the present disclosure.

The sensor device 440 may include a gyro sensor 441 or an acceleration sensor 443. The gyro sensor 441 may sense information about the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on when the user input device 435 is operated or a signal is transmitted/received to/from the image display apparatus 100 through the wireless transceiver 425, a vibration module 453 for generating a vibration, an audio output device 455 for outputting an audio, or a display module 457 for outputting an image.

The power supply 460 supplies power to the remote controller 200. When the remote controller 200 is not moved for a certain time, the power supply 460 may stop the supply of power to reduce a power waste. The power supply 460 may resume power supply when a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information about a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that can wirelessly transmit and receive a signal to and from the remote controller 200 and a coordinate value calculator 415 that can calculate the coordinate value of a pointer corresponding to the operation of the remote controller 200.

The user input interface 150 may wirelessly transmit and receive a signal to and from the remote controller 200 through the RF module 412. In addition, the user input interface 150 may receive a signal transmitted by the remote controller 200 through the IR module 413 according to an IR communication standard.

The coordinate value calculator 415 may correct a handshake or an error from a signal corresponding to the operation of the remote controller 200 received through the wireless transceiver 151 and may calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of handshake or error.

For another example, unlike the drawing, the coordinate value calculator 415 may be provided in the signal processor 170, not in the user input interface 150.

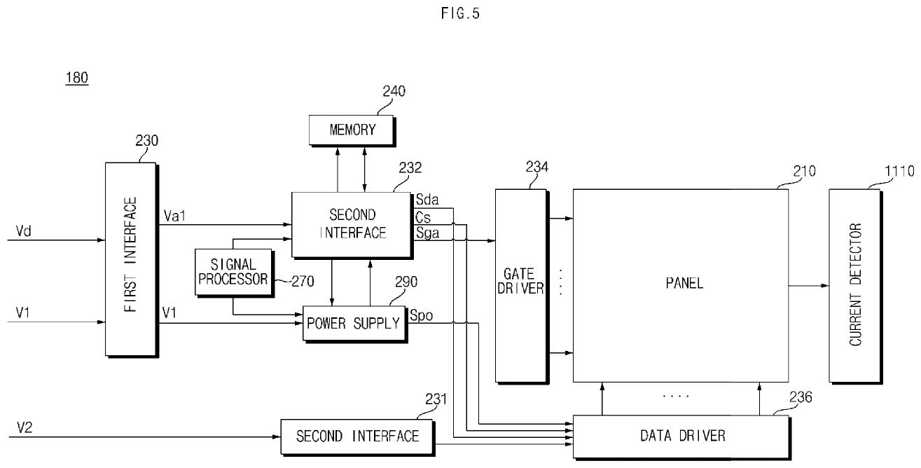

FIG. 5 is an internal block diagram of a display of FIG. 2.

Referring to FIG. 5, the organic display 180 including light emitting diode panel may include an organic light emitting diode panel 210, a first interface 230, a second interface 231, a timing controller 232, a gate driver 234, a data driver 236, a memory 240, a signal processor 270, a power supply 290, a current detector 510, and the like.

The display 180 receives an image signal Vd, a first DC power V1, and a second DC power V2, and may display a certain image based on the image signal Vd.

Meanwhile, the first interface 230 in the display 180 may receive the image signal Vd and the first DC power V1 from the signal processor 170.

Here, the first DC power V1 may be used for the operation of the power supply 290 and the timing controller 232 in the display 180.

Next, the second interface 231 may receive a second DC power V2 from an external power supply 190. Meanwhile, the second DC power V2 may be input to the data driver 236 in the display 180.

The timing controller 232 may output a data driving signal Sda and a gate driving signal Sga, based on the image signal Vd.

For example, when the first interface 230 converts the input image signal Vd and outputs the converted image signal va1, the timing controller 232 may output the data driving signal Sda and the gate driving signal Sga based on the converted image signal va1.

The timing controller 232 may further receive a control signal, a vertical synchronization signal Vsync, and the like, in addition to the image signal Vd from the signal processor 170.

In addition to the image signal Vd, based on a control signal, a vertical synchronization signal Vsync, and the like, the timing controller 232 generates a gate driving signal Sga for the operation of the gate driver 234, and a data driving signal Sda for the operation of the data driver 236.

Meanwhile, the timing controller 232 may further output a control signal Cs to the gate driver 234.

The gate driver 234 and the data driver 236 supply a scan signal, and an image signal to the organic light emitting diode panel 210 through a gate line GL and a data line DL respectively, according to the gate driving signal Sga and the data driving signal Sda from the timing controller 232. Accordingly, the organic light emitting diode panel 210 displays a certain image.

Meanwhile, the organic light emitting diode panel 210 may include an organic light emitting layer. In order to display an image, a plurality of gate lines GL and data lines DL may be disposed in a matrix form in each pixel corresponding to the organic light emitting layer.

Meanwhile, the data driver 236 may output a data signal to the organic light emitting diode panel 210 based on a second DC power V2 from the second interface 231.

The power supply 290 may supply various power supplies to the gate driver 234, the data driver 236, the timing controller 232, and the like.

A current detector 1110 may detect the current flowing in a subpixel of the organic light emitting diode panel 210.

The detected current may be input to the processor 270 or the like, for an accumulated current calculation.

The signal processor 270 may perform each type of control of the display 180. For example, the processor 270 may control the gate driver 234, the data driver 236, the timing controller 232, and the like.

Meanwhile, the signal processor 270 may receive current information flowing in a subpixel of the organic light emitting diode panel 210 from the current detector 510.

In addition, the signal processor 270 may calculate the accumulated current of each subpixel of the organic light emitting diode panel 210, based on information of current flowing through the subpixel of the organic light emitting diode panel 210. The calculated accumulated current may be stored in the memory 240.

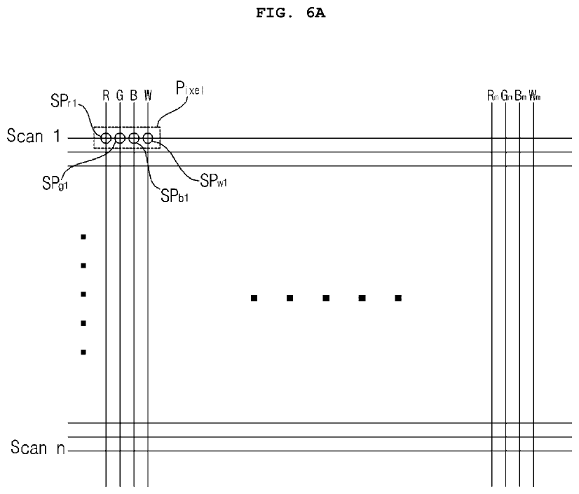

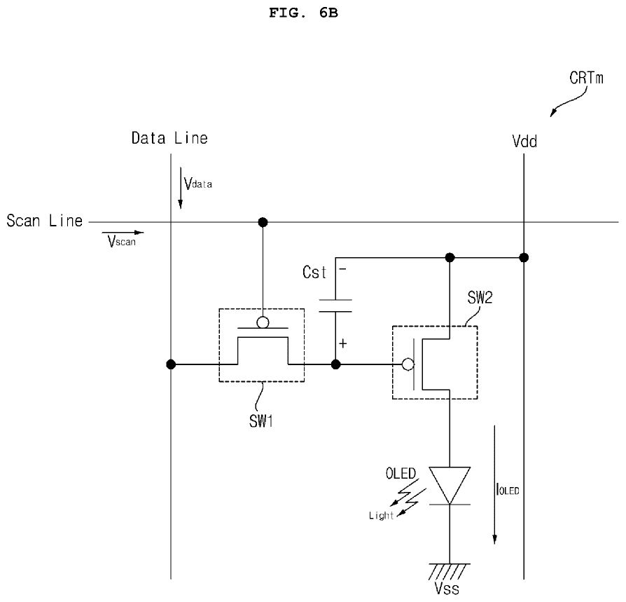

FIG. 6A and FIG. 6B are diagrams referred to in the description of an organic light emitting diode panel of FIG. 5. Firstly, FIG. 6A is a diagram illustrating a pixel in the organic light emitting diode panel 210.

Referring to drawing, the organic light emitting diode panel 210 may include a plurality of scan lines Scan 1 to Scan n and a plurality of data lines R1, G1, B1, W1 to Rm, Gm, Bm, Wm intersecting the scan lines.

Meanwhile, a pixel (subpixel) is defined in an intersecting area of the scan line and the data line in the organic light emitting diode panel 210. In the drawing, a pixel including subpixels SR1, SG1, SB1 and SW1 of RGBW is shown.

FIG. 6B illustrates a circuit of any one subpixel in the pixel of the organic light emitting diode panel of FIG. 6A.

Referring to drawing, an organic light emitting sub pixel circuit (CRTm) may include, as an active type, a switching transistor SW1, a storage capacitor Cst, a drive transistor SW2, and an organic light emitting layer (OLED).

The switching transistor SW1 is turned on according to the input scan signal Vdscan, as a scan line is connected to a gate terminal. When it is turned on, the input data signal Vdata is transferred to the gate terminal of the drive transistor SW2 or one end of the storage capacitor Cst.

The storage capacitor Cst is formed between the gate terminal and the source terminal of the drive transistor SW2 and stores a certain difference between a data signal level transmitted to one end of the storage capacitor Cst and a DC power (VDD) level transmitted to the other terminal of the storage capacitor Cst.

For example, when the data signal has a different level according to a Plume Amplitude Modulation (PAM) method, the power level stored in the storage capacitor Cst varies according to the level difference of the data signal Vdata.

For another example, when the data signal has a different pulse width according to a Pulse Width Modulation (PWM) method, the power level stored in the storage capacitor Cst varies according to the pulse width difference of the data signal Vdata.

The drive transistor SW2 is turned on according to the power level stored in the storage capacitor Cst. When the drive transistor SW2 is turned on, the driving current (IOLED), which is proportional to the stored power level, flows in the organic light emitting layer (OLED). Accordingly, the organic light emitting layer OLED performs a light emitting operation.

The organic light emitting layer OLED may include a light emitting layer (EML) of RGBW corresponding to a subpixel and may include at least one of a hole injecting layer (HIL), a hole transporting layer (HTL), an electron transporting layer (ETL), or an electron injecting layer (EIL). In addition, it may include a hole blocking layer, and the like.

Meanwhile, all the subpixels emit a white light in the organic light emitting layer OLED. However, in the case of green, red, and blue subpixels, a subpixel is provided with a separate color filter for color implementation. That is, in the case of green, red, and blue subpixels, each of the subpixels further includes green, red, and blue color filters. Meanwhile, since a white subpixel outputs a white light, a separate color filter is not required.

Meanwhile, in the drawing, it is illustrated that a p-type MOSFET is used for the switching transistor SW1 and the drive transistor SW2, but an n-type MOSFET or other switching element such as a JFET, IGBT, SIC, or the like are also available.

Meanwhile, the pixel is a hold type element that continuously emits light in the organic light emitting layer (OLED), after a scan signal is applied, during a unit display period, specifically, during a unit frame.

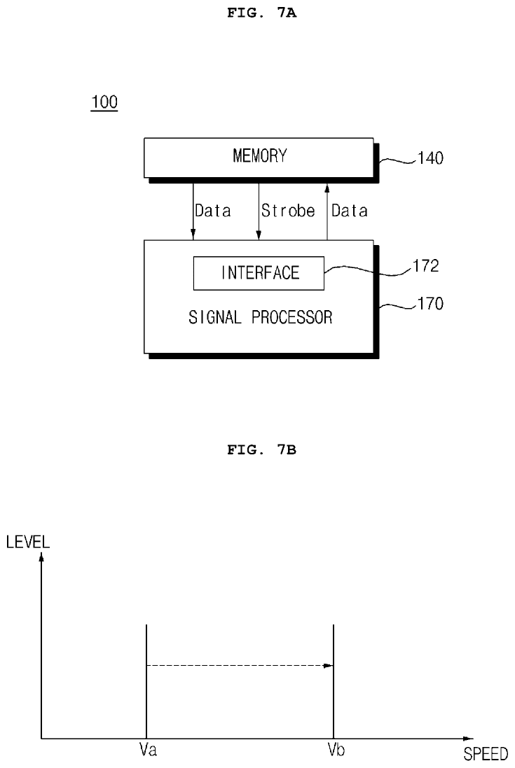

FIG. 7A illustrates a memory and a signal processor within an electronic apparatus according to one embodiment of the present disclosure, and FIGS. 7B to 14 are diagrams referred to in the description of the signal processor of FIG. 7A.

First, referring to FIG. 7A, an electronic apparatus 100 according to one embodiment of the present disclosure may include a memory 140 storing data, and a signal processor 170 receiving a strobe signal Strobe and data from the memory 140.

In particular, the signal processor 170 may include an interface 172 receiving the strobe signal Strobe and the data.

Meanwhile, the data may include odd data received during an odd data period Pma and even data received during an even data period Pmb.

The interface 172 within the signal processor 170 according to one embodiment of the present disclosure generates a first strobe signal Strobe_Odd for the odd data based on the received strobe signal Strobe, generate a second strobe signal Strobe_Even for the even data based on the received strobe signal Strobe, detect the odd data based on the first strobe signal Strobe_Odd, and detect the even data based on the second strobe signal Strobe Even. Accordingly, data may be received in a stable manner from the memory 140. In particular, an improved effective area may be secured at the time of data reception based on the first strobe signal Strobe_Odd and the second strobe signal Strobe_Even.

FIG. 7B illustrates a data transmission speed Va and a data transmission speed Vb, which is larger than Va.

For example, when the transmission speed of data received from the memory 140 to the signal processor 170 increases from Va to Vb, the odd data period and the even data period may have duty cycles different from each other.

In particular, as the transmission speed of data received from the memory 140 to the signal processor 170 increases, a difference between duty cycles of the odd and even data periods may increase.

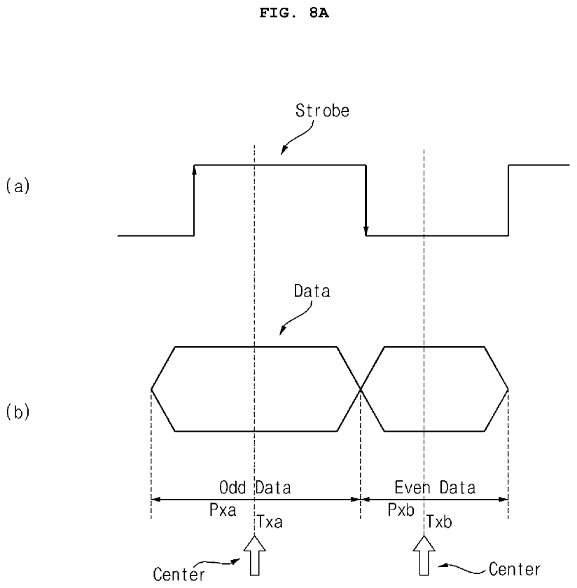

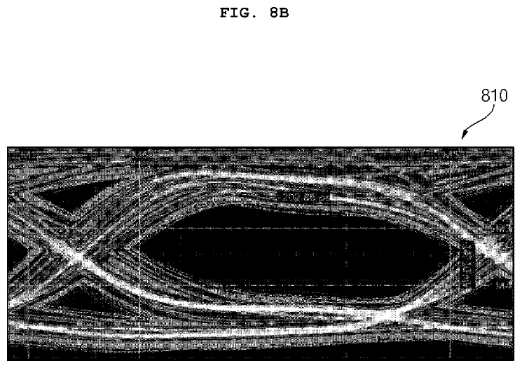

FIG. 8A(a) illustrates a strobe signal Strobe, and FIG. 8A(b) illustrates one example of a data signal Data.

Referring to the figure, when the transmission speed of data received from the memory 140 to the signal processor 170 is Vb, a difference between duty cycles of the odd data period PXa during which odd data are received and the even data period PXb during which even data are received may increase.

FIG. 8A(b) illustrates a case in which the duty cycle of the odd data period PXa is larger than the duty cycle of the even data period PXb. The difference may further increase as the transmission speed of data received from the memory 140 to the signal processor 170 increases.

Meanwhile, as shown in FIG. 8A, when odd and even data are received using a common strobe signal Strobe for the odd data period PXa and the even data period PXb, the center point Txa of the odd data, and the center point Txb of the even data are detected as being not in the center areas of the odd data period PXa and the even data period PXb.

Accordingly, when odd and even data are detected or received respectively using the center point Txa of odd data, and the center point Txb of even data, a disadvantage occurs in that the size of an effective area becomes small.

In particular, as the transmission speed of data received from the memory 140 to the signal processor 170 increases, the size of the effective area decreases.

FIG. 8B illustrates an eye pattern showing the odd data period PXa and the even data period PXb together.

Referring to the figure, in the eye pattern, the size of an area in which an odd data graph and an even data graph are not shown decreases.

In particular, as the transmission speed of data received from the memory 140 to the signal processor 170 increases, the size of an area in which an odd data graph and an even data graph are not shown becomes small. In other words, the size of an effective area for data detection decreases.

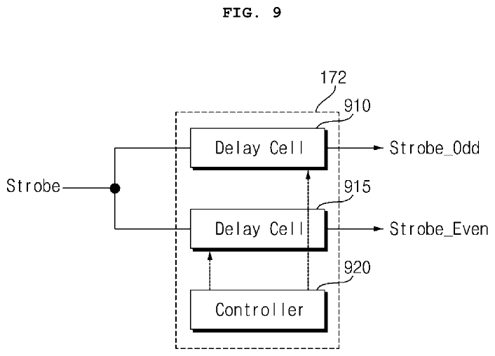

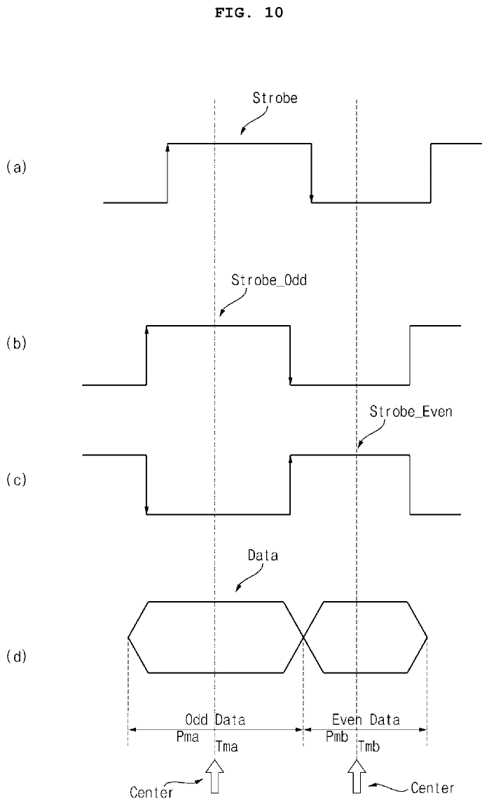

To solve the problem above, one embodiment of the present disclosure proposes a method for detecting odd data, and even data using a first strobe data for odd data, and a second strobe signal for even data rather than using a common strobe signal. The method will be described with reference to FIGS. 9 and 10.

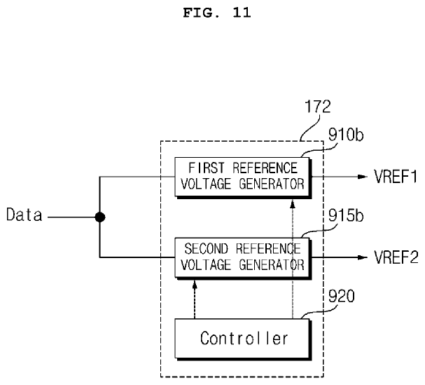

Meanwhile, another embodiment of the present disclosure proposes a method for detecting odd data, and even data using a first reference voltage for odd data, and a second reference voltage for even data rather than using a common reference voltage. The method will be described with reference to FIGS. 11 to 14.

FIG. 9 illustrates one example of an internal block diagram of the interface 172 of the signal processor 170 according to an embodiment of the present disclosure, FIG. 10(a) illustrates a strobe signal Strobe, FIG. 10(b) illustrates an odd strobe signal, FIG. 10(c) illustrates an even strobe signal, and FIG. 10(d) illustrates a data signal Data.

Referring to FIG. 9, the interface 172 within the signal processor 170 may include a first delay cell 910 generating a first strobe signal Strobe_Odd for odd data based on the strobe signal Strobe and a second delay cell 915 generating a second strobe signal Strobe_Even for even data based on the strobe signal Strobe. Accordingly, data may be received in a stable manner from the memory. In particular, an improved effective area may be secured at the time of data reception based on the first strobe signal Strobe_Odd and the second strobe signal Strobe_Even.

Meanwhile, referring to FIG. 9, the interface 172 within the signal processor 170 may further include a controller 920 controlling the first delay cell 910 and the second delay cell 915. Accordingly, data may be received in a stable manner from the memory 140.

Meanwhile, as shown in FIG. 10(a), the interface 172 within the signal processor 170 may generate the first strobe signal Strobe_odd for odd data as shown in FIG. 10(b), based on the received strobe signal Strobe as shown in FIG. 10(a) and generate the second strobe signal Strobe_Even for even data as shown in FIG. 10(c), based on the strobe signal Strobe.

Meanwhile, the interface 172 within the signal processor 170 may detect odd data, as shown in FIG. 10(d), based on the first strobe signal Strobe_Odd and detect even data, as shown in FIG. 10(d), based on the second strobe signal Strobe_Even. Accordingly, data may be received in a stable manner from the memory 140. In particular, an improved effective area may be secured at the time of data reception based on the first strobe signal Strobe_Odd and the second strobe signal Strobe_Even.

Meanwhile, when the odd data period Pma and the even data period Pmb have different duty cycles, the interface 172 within the signal processor 170 may detect odd data based on the first strobe signal Strobe_Odd and detect even data based on the second strobe signal Strobe_Even. Accordingly, data may be received in a stable manner from the memory 140.

Meanwhile, in response to the odd data period and the even data period having different duty cycles, the interface 172 within the signal processor 170 may detect a first center point Tma for the odd data, as shown in FIG. 10(d), based on the first strobe signal Strobe_Odd, detect the odd data based on the first center point Tma, detect a second center point Tmb for the even data, as shown in FIG. 10(d), based on the second strobe signal Strobe_Even, and detect the even data based on the second center point Tmb.

Compared with FIG. 8A, since the first center point Tma and the second center point Tmb become closer to the center areas of the first strobe signal Strobe_Odd and the second strobe signal Strobe_Even respectively and become closer to the center areas of the odd data period Pma and the even data period Pmb, data may be received in a stable manner from the memory 140. In particular, based on the first strobe signal Strobe_Odd and the second strobe signal Strobe_Even, the improved effective area at the time of data reception increases more than that of FIG. 8A. Therefore, it is possible to secure an effective area in a stable manner at the time of data reception.

Meanwhile, the margin of odd data, and even data detected based on the first strobe signal Strobe_Odd and the second strobe signal Strobe_Even as shown in FIG. 10 is larger than the margin of odd data, and even data detected based on a strobe signal Strobe from the memory 140 as shown in FIG. 8(A). Accordingly, data may be received in a stable manner from the memory 140.

Meanwhile, as the frequency of the strobe signal Strobe or the transmission speed of received data increases, the margin of odd data, and even data detected based on the first strobe signal Strobe_Odd and the second strobe signal Strobe_Even as shown in FIG. 10 increases more than the margin of odd data, and even data detected based on a strobe signal Strobe from the memory 140 as shown in FIG. 8(A). Accordingly, even if the frequency of the strobe signal Strobe or the transmission speed of received data increases, data may be received in a stable manner from the memory 140.

Meanwhile, as the frequency of the strobe signal Strobe or the transmission speed of the received data increases, a difference between duty cycles of the odd data period Pma and the even data period Pmb may increase, and a difference between the margin of odd data, and even data detected based on the strobe signal Strobe from the memory as shown in FIG. 8A and the margin of odd data, and even data detected based on the first strobe signal Strobe_Odd and the second strobe signal Strobe_Even may increase. Accordingly, even if the frequency of a strobe signal Strobe or the transmission speed of received data increases, data may be received in a stable manner from a memory.

FIG. 11 shows one example of an internal block diagram of an electronic apparatus according to another embodiment of the present disclosure.

Referring to the figure, the interface 172 within the signal processor 170 according to another embodiment of the present disclosure may include a first reference voltage generator 910b generating the first reference voltage VREF1 based on odd data among the data, and a second reference voltage generator 915b generating the second reference voltage VREF2 based on even data among the data. Accordingly, data may be received in a stable manner from the memory 140.

Meanwhile, the interface 172 within the signal processor 170 according to another embodiment of the present disclosure may further include a controller 920 controlling the first reference voltage generator 910b and the second reference voltage generator 915b. Accordingly, data may be received in a stable manner from the memory 140.

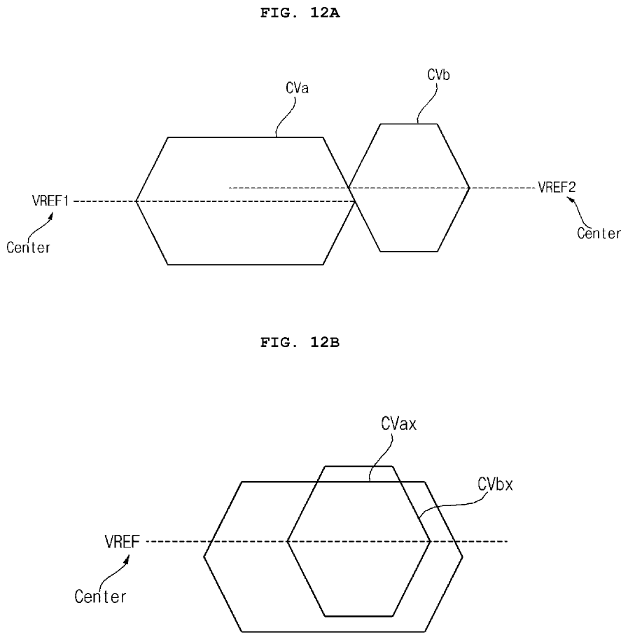

FIG. 12A illustrates a first reference voltage VREF1 corresponding to an odd data waveform CVa and a second reference voltage VREF2 corresponding to an even data waveform CVb according to another embodiment of the present disclosure, and FIG. 12B illustrates a reference voltage VREF common to the odd data waveform CVax and even data waveform CVbx.

Meanwhile, as shown in FIG. 12A, the interface 172 within the signal processor 170 according to another embodiment of the present disclosure may detect the first reference voltage VREF1 corresponding to the odd data waveform CVa and the second reference voltage VREF2 corresponding to the even data waveform CVv and detect odd data based on the first reference voltage VREF1 and even data based on the second reference voltage VREF2.

Accordingly, data may be received in a stable manner from the memory 140. In particular, an improved effective area may be secured at the time of data reception based on the first reference voltage VREF1 and the second reference voltage VREF2.

Meanwhile, as shown in FIG. 12A, when different reference voltages are applied to the odd data waveform CVa and the even data waveform CVb, the interface 172 within the signal processor 170 according to another embodiment of the present disclosure may detect the odd data based on the first reference voltage VREF1 and detect the even data based on the second reference voltage VREF2. Accordingly, data may be received in a stable manner from the memory 140. In particular, an improved effective area may be secured at the time of data reception based on the first reference voltage VREF1 and the second reference voltage VREF2.

Meanwhile, the margin of odd data, and even data detected based on the first reference voltage VREF1 and the second reference voltage VREF2 as shown in FIG. 12A is larger than the margin of odd data, and even data detected based on a common reference voltage VREF commonly corresponding to the odd data waveform CVax and the even data waveform CVbx as shown in FIG. 12B. Accordingly, data may be received in a stable manner from the memory 140.

Meanwhile, as the frequency of the strobe signal Strobe and the transmission speed of received data increases, the margin of odd data, and even data detected based on the first reference voltage VREF1 and the second reference voltage VREF2 as shown in FIG. 12A increases more than the margin of odd data, and even data detected based on a common reference voltage VREF commonly corresponding to the odd data waveform CVax and the even data waveform CVbx as shown in FIG. 12B. Accordingly, even if the frequency of the strobe data Strobe or the transmission speed of received data increases, data may be received in a stable manner from the memory 140.

Meanwhile, as the frequency of the strobe signal Strobe and the transmission speed of received data increases, a voltage difference between the odd data period Pma and the even data period Pmb increases, as shown in FIG. 12A, and a difference between the margin of odd data, and even data detected based on the first reference voltage VREF1 and the second reference voltage VREF2 as shown in FIG. 12A and the margin of odd data, and even data detected based on a common reference voltage VREF commonly corresponding to the odd data, and the even data as shown in FIG. 12B may increase. Accordingly, even if the frequency of the strobe data Strobe or the transmission speed of received data increases, data may be received in a stable manner from the memory 140.

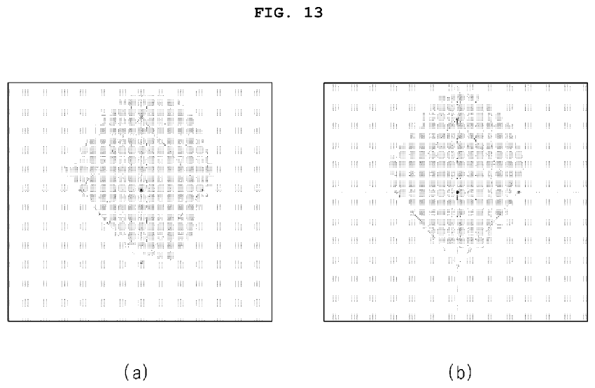

FIG. 13(a) shows a plot of an odd data group detected by the first strobe signal Strobe Odd according to the method of FIG. 10, and FIG. 13(b) shows a plot of an even data group detected by the second strobe signal Strobe Even according to the method of FIG. 10.

Accordingly, as shown in the figure, the size of the effective area increases compared to the method of FIG. 8A; therefore, the signal processor 170 may receive or detect data in a stable manner from the memory 140.

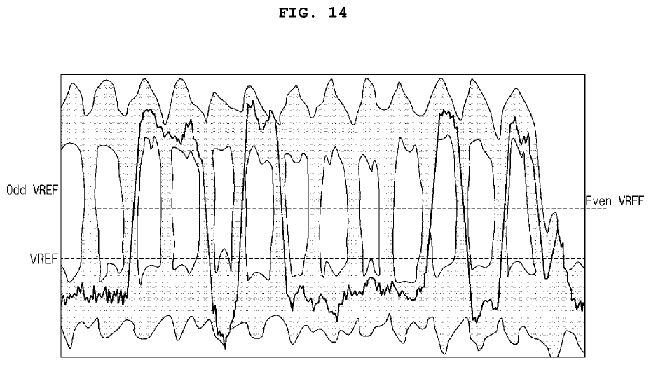

FIG. 14 illustrates the positions of the first reference voltage VREF1 and the second reference voltage VREF2 of received data according to the method of FIG. 12A.

Accordingly, the size of the effective area increases compared to the method of FIG. 12B; therefore, the signal processor 170 may receive or detect data in a stable manner from the memory 140.

As a result, the method of FIG. 10 may correspond to an x-axis compensation method for received data, and the method of FIG. 12A may correspond to a y-axis compensation method for received data.

Meanwhile, it is possible to apply the method of FIG. 10 and the method of FIG. 12A simultaneously.

In other words, the first delay cell 910 of FIG. 9 may include the first reference voltage generator 910b of FIG. 11 and perform the corresponding operation, and the second delay cell 915 of FIG. 9 may include the second reference voltage generator 915b of FIG. 11 and perform the corresponding operation.

Accordingly, according to another embodiment of the present disclosure, it is possible to detect odd data based on the first strobe signal Strobe_Odd and the first reference voltage VREF1 and to detect even data based on the second strobe signal Strobe_Even and the second reference voltage VREF2. Accordingly, securing a significant effective area during actual data reception is possible.

While the present disclosure has been particularly shown and described with reference to exemplary embodiments thereof, it is clearly understood that the present disclosure is not limited to the specific embodiment described above, and various modifications are available to those skilled in the art without departing from the subject matter claimed in the accompanying claims. Further, the various modifications should not be individually understood from the technical concept or prospect of the present disclosure.

### INDUSTRIAL APPLICABILITY

The present disclosure may be applied to a signal processing device and an electronic apparatus including the same.

1. An electronic apparatus comprising:
a memory configured to store data; and
a signal processor configured to receive a strobe signal and data from the memory,
wherein the data include odd data received during an odd data period and even data received during an even data period, and
wherein the signal processor is configured to:
generate a first strobe signal for the odd data based on the received strobe signal,
generate a second strobe signal for the even data based on the received strobe signal,
detect the odd data based on the first strobe signal, and
detect the even data based on the second strobe signal.

2. The electronic apparatus of claim 1, wherein, in response to the odd data period and the even data period having different duty cycles,
the signal processor is configured to detect the odd data based on the first strobe signal, and detect the even data based on the second strobe signal.

3. The electronic apparatus of claim 1, wherein, in response to the odd data period and the even data period having different duty cycles,
the signal processor is configured to detect a first center point for the odd data based on the first strobe signal, detect the odd data based on the first center point,
detect a second center point for the even data based on the second strobe signal, and detect the even data based on the second center point.

4. The electronic apparatus of claim 1, wherein the margin of odd data, and even data detected based on the strobe signal from the memory is larger than the margin of odd data, and even data detected based on the first strobe signal, and the second strobe signal.

5. The electronic apparatus of claim 1, wherein, as the frequency of the strobe signal or the transmission speed of the received data increases,
the margin of odd data, and even data detected based on the first strobe signal, and the second strobe signal increases more than the margin of odd data, and even data detected based on the strobe signal from the memory.

6. The electronic apparatus of claim 1, wherein, as the frequency of the strobe signal or the transmission speed of the received data increases, a difference between duty cycles of the odd data period and the even data period increases, and
a difference between the margin of odd data, and even data detected based on the strobe signal from the memory and the margin of odd data, and even data detected based on the first strobe signal, and the second strobe signal increases.

7. The electronic apparatus of claim 1, wherein the signal processor includes
a first delay cell configured to generate a first strobe signal for the odd data based on the strobe signal; and
a second delay cell configured to generate a second strobe signal for the even data based on the strobe signal.

8. The electronic apparatus of claim 7, wherein the signal processor further includes a controller controlling the first delay cell and the second delay cell.

9. An electronic apparatus comprising:
a memory configured to store data, and
a signal processor configured to receive a strobe signal and data from the memory,
wherein the data include odd data received during an odd data period and even data received during an even data period, and
the signal processor is configured to:
generate a first reference voltage corresponding to the odd data,
generate a second reference voltage corresponding to the even data,
detect the odd data based on the first reference voltage, and
detect the even data based on the second reference voltage.

10. The electronic apparatus of claim 9, wherein, in response to the odd data period and the even data period having different reference voltages,
the signal processor is configured to detect the odd data based on the first reference voltage and
detect the even data based on the second reference voltage.

11. The electronic apparatus of claim 9, wherein the margin of odd data, and even data detected based on the first reference voltage and the second reference voltage is larger than the margin of odd data, and even data detected based on a common reference voltage commonly corresponding to the odd data, and the even data.

12. The electronic apparatus of claim 9, wherein, as the frequency of the strobe signal or the transmission speed of the received data increases,
the margin of odd data, and even data detected based on the first reference voltage and the second reference voltage increases more than the margin of odd data, and even data detected based on a common reference voltage commonly corresponding to the odd data, and the even data.

13. The electronic apparatus of claim 9, wherein, as the frequency of the strobe signal or the transmission speed of the received data increases, a voltage difference between the odd data period and the even data period increases, and
a difference between the margin of odd data, and even data detected based on a common reference voltage commonly corresponding to the odd data, and the even data, and the margin of odd data, and even data detected based on the first reference voltage and the second reference voltage increases.

14. The electronic apparatus of claim 9, wherein the signal processor includes a first reference voltage generator configured to generate the first reference voltage based on odd data among the data, and
a second reference voltage generator configured to generate the second reference voltage based on even data among the data.

15. The electronic apparatus of claim 14, wherein, the signal processor further includes a controller controlling the first reference voltage generator and the second reference voltage generator.

16. A signal processing device receiving a strobe signal from a memory, odd data received during an odd data period, and even data received during an even data period,
wherein the signal processing device includes a first delay cell configured to generate a first strobe signal for the odd data based on the received strobe signal, and
a second delay cell configured to generate a second strobe signal for the even data based on the received strobe signal, detect the odd data based on the first strobe signal, and detect the even data based on the second strobe signal.

17. The signal processing device of claim 16, wherein, in response to the odd data period and the even data period having different duty cycles,
the signal processing device is configured to detect a first center point for the odd data based on the first strobe signal, detect the odd data based on the first center point,
detect a second center point for the even data based on the second strobe signal, and detect the even data based on the second center point.

18. The signal processing device of claim 16, wherein the margin of odd data, and even data detected based on the strobe signal from the memory is larger than the margin of odd data, and even data detected based on the first strobe signal, and the second strobe signal.

19. The signal processing device of claim 16, wherein, as the frequency of the strobe signal or the transmission speed of the received data increases,
the margin of odd data, and even data detected based on the first strobe signal, and the second strobe signal increases more than the margin of odd data, and even data detected based on the strobe signal from the memory.

20. The signal processing device of claim 16, wherein, as the frequency of the strobe signal or the transmission speed of the received data increases, a difference between duty cycles of the odd data period and the even data period increases, and
a difference between the margin of odd data, and even data detected based on the strobe signal from the memory and the margin of odd data, and even data detected based on the first strobe signal, and the second strobe signal increases.
